(19) United States
(12) Patent Application Publication
(10) Pub. No.: US 2025/0058347 A1
(43) Pub. Date: Feb. 20, 2025

(54) LOADING DEVICE FOR A COATING SYSTEM AND A COATING SYSTEM

(71) Applicant: Schwäbische Werkzeugmaschinen GmbH, Schramberg-Waldmössingen (DE)

(72) Inventor: Hartmut ROCKER, Tettnang (DE)

(21) Appl. No.: 18/807,631

(22) Filed: Aug. 16, 2024

(30) Foreign Application Priority Data
Aug. 18, 2023 (EP) 23192189.1

(51) Int. Cl. B05C 13/00; B05C 9/14; B65G 47/34

(52) U.S. Cl. CPC B05C 13/00; B05C 9/14; B65G 47/34

(57) ABSTRACT

A loading device for a coating system with a holding device which includes a rack-like frame and a carrier made of a rod-like or wire-like continuous material. On which a workpiece can be arranged, with at least one detection device which includes a detection means, by which at least the dimensions of the frame and of the workpiece can be detected, and which includes a control unit, by which the dimensions of the hook-like holding section and of a minimum distance between two hook-like holding sections on the carrier for contact-free arrangement of the workpiece and by which the total length of the continuous material for forming the carrier can be determined. With a provisioning device which interacts functionally with the detection device, by which the carrier can be produced, which provides a continuous material carrier, which provides the continuous material forming the carrier, which provides a deformation unit.

The invention relates to a loading device for a coating system and a coating system.

Coating systems are used to coat parts, in particular workpieces, with a coating agent such as varnish or paint. In these, the workpieces are sprayed with the coating agent and then cured in a heating unit, such as an oven.

In the known coating systems, several workpieces are arranged on carriers of a holding unit and the holding unit loaded in this way is transferred to a conveyor system through which the workpieces are fed to the coating unit and then to the heating unit. After the coating on the workpieces has hardened, the holding unit is fed to an unloading device, where the holding unit is removed from the conveyor system and the workpieces are then removed from the holding unit.

It has proven to be a disadvantage that coating the workpieces with coating agent can never completely prevent components of the holding unit from being coated with the coating agent and having to be cleaned before being used again.

This proves to be particularly disadvantageous if the coating system is designed in such a way that the workpieces are electrically energised by the holding unit during coating in order to improve adhesion of the coating agent. In this case, it is disadvantageous if the holding unit is increasingly coated with the coating agent and thus becomes electrically insulated. In this case, the conduction of electric current through the holding unit to the workpieces is prevented or at least reduced due to the increasing insulating effect of the coating agent.

Cleaning the individual components of the holding device proves to be inconvenient and time-consuming and therefore cost-intensive. In order to save costs, coating systems are known from the state of the art in which the holding devices comprise wire-like hooks which are suspended from the carriers of the holding device and on which a workpiece is suspended in each case. After a coating cycle, the coated wire hooks are disposed of and replaced with new wire hooks. The arrangement of the wire hooks on the carriers and the arrangement of the workpieces on the wire hooks proved to be time-consuming.

### SUMMARY

One task of an embodiment of the invention is to propose a loading device and a coating system in which the arrangement of workpieces on a holding device can be designed more efficiently.

This task is solved by a loading device for a coating system with at least one holding device which comprises at least one rack-like frame and at least one carrier made of a rod-like or wire-like continuous material, which can be or is secured with one end to the frame and on which at least one hook-like holding section is formed, on which a workpiece to be coated can be arranged, with at least one detection device which comprises a detection means, by which at least the dimensions of the frame and of the workpiece can be detected, and which comprises at least one control unit, by which, on the basis of the dimensions of the frame and the workpiece, the dimensions of the at least one hook-like holding section and of a minimum distance between two hook-like holding sections on the carrier for contact-free arrangement of the workpiece and by which the total length of the continuous material for forming the carrier can be determined, and with at least one provisioning device which interacts functionally with the detection device, by which the carrier can be produced, which provides a continuous material carrier, which provides the continuous material forming the carrier, which provides a deformation unit, by which a hook-like holding section can be moulded by an region-wise plastic deformation of the provided continuous material in accordance with the determined dimensions and the determined minimum distance, and which provides a cutting means, with which the provided continuous material can be cut once the total length of the remaining continuous material carrier is achieved.

By the fact that the loading device comprises a provisioning device in which the carrier and the hook-like holding sections can be provided from a continuous material on the basis of the data recorded by the detection means, a loading process can be designed more efficiently. In particular, the wire hooks known from the previous state of the art and their arrangement on the carrier can be dispensed with, which saves time.

The fact that the loading device comprises a detection device with which the dimensions of the frame and the workpiece can be detected means that the carriers can be optimally adjusted in the provisioning device. This makes it possible to adapt the carrier and the hook-like holding sections provided therein to the respective workpiece. This improves the area and space optimised use of the holding device, which can optimise the number of workpieces to be processed, in particular the workpieces to be coated.

The total length of the continuous material cut from the continuous material and forming the carrier is understood to be the length required to form just the carrier sections and the hook-like holding sections.

In principle, it is conceivable that the hook-like holding sections could be cut to length from the continuous material carrier and fixed to the carrier as additional, separate components. However, an embodiment of the loading device is preferred in which the carrier and the at least one hook-like holding section form a common, one-piece component.

In principle, the deformation unit can be designed in any technical way as long as the hook-shaped holding section can be provided by it. In one embodiment of the loading device, it is provided that the at least one deformation unit of the provisioning device comprises a contact means which is arranged parallel to the direction of extension of the continuous material provided and which comprises a continuous opening, and that the at least one deformation unit of the provisioning device comprises a pulling means which engages behind the continuous material provided on a side facing away from the contact means and transfers the hook-like holding section to be formed through the opening transversely or obliquely to the direction of extension of the continuous material provided.

If the deformation unit of the provisioning device comprises a contact means through the opening of which an area of the continuous material can be pushed through, this pushed-through area can be deformed without the other, in particular adjacent, areas of the continuous material being deformed.

In a further development of the last-mentioned embodiment, it proves to be advantageous if the at least one deformation unit of the provisioning device comprises at least one twisting means, by means of which the hook-like holding section to be formed which is transferred through the opening of the contact means can be plastically deformed by twisting and/or if the at least one deformation unit of the provisioning device comprises at least one bending means, by means of which the hook-like holding section to be formed which is transferred through the opening of the contact means can be deformed by bending.

If the deformation unit of the provisioning device comprises at least one twisting means, the continuous material can be twisted to form the hook-like holding section. This can increase the torsional rigidity of the hook-like holding section, allowing workpieces with a higher weight to be placed on the hook-like holding section without plastically deforming it.

When the deformation unit comprises a bending means, the hook-like holding section can be deformed by bending, whereby a workpiece comprising, for example, a mount formed by a through-opening, forming a rear grip, can be arranged on a hook-like holding section. This can ensure that the workpiece cannot be unintentionally removed from the hook-like section when the holding device is moved.

In principle, the carrier can be positioned anywhere on the frame. There are conceivable embodiments of the loading device, in which at least one of the at least one hook-like holding section moulded on the carrier forms a horizontal region in the configuration of the carrier fixed to the frame, which opens into the carrier and comprises a vertical area which opens into the horizontal area and has a free end for positioning the workpiece on the side facing away from the horizontal area, wherein the hook-like holding section is arranged with both the horizontal area and the vertical area running parallel to a plane spanned by the frame, or wherein the hook-like holding section is arranged with the horizontal region or with the vertical region extending perpendicular to a plane spanned by the frame.

If the hook-like holding sections are designed in such a way that their horizontal area and vertical area run in the plane of the frame, workpieces can be arranged on the hook-like holding sections in such a way that they run with their largest surfaces transverse to the plane of the frame. The workpieces thus reach through the frame.

The number of the workpieces arranged on the frame can therefore be increased.

If the hook-like holding sections are arranged in such a way, so that either one horizontal area or one vertical area runs vertically to the plane spanned by the frame, the workpieces arranged on the hook-like holding sections are arranged for the most part parallel to the plane of the frame with their largest surface.

In addition, embodiments of the loading device are conceivable in which two neighbouring hook-like holding sections formed on the same carrier are each arranged on an opposite side with respect to the carrier. This allows the workpieces to be arranged to the left and right of the carrier, which increases the loading density of the holding device.

In principle, the detection means can be of any design as long as it fulfils the technical function of detecting at least the dimensions of the frame and the workpiece. In embodiments of the loading device, it is provided that at least one of the at least one detection means comprises at least one manually operable input means by which at least the dimensions of the frame and of the workpiece can be entered and/or that at least one of the at least one detection means comprises at least one sensor means by which at least the dimensions of the frame and of the workpiece can be detected automatically.

If at least one of the at least one detection means comprises at least one manually operable input means, the data for the frame and the workpiece can be entered manually. This means that the loading device can be technically simple.

If at least one of the at least one detection means comprises at least one sensor means, the dimensions of the frame and the workpieces can be detected automatically. This increases the degree of automation of the loading device and makes it possible to load the holding device or provision of the carrier comprising the at least one hook-shaped holding section more efficiently.

The detection means can be functionally assigned to the control unit.

Furthermore, it proves to be advantageous if the control unit comprises a calculation means by which the dimensions of the at least one hook-like retaining section, the minimum distance between two hook-like retaining sections and the total length of the continuous material can be calculated and/or if the control unit comprises a memory means in which the values for the dimensions of the at least one hook-like retaining section, the minimum distance between two hook-like retaining sections and the total length of the continuous material are stored.

If the control unit comprises a calculating device, it can always calculate the necessary data depending on the situation.

If the control unit comprises a memory means in which the values for the dimensions of the at least one hook-like retaining section, the distance between two hook-like retaining sections and the total length of the continuous material are stored, the control unit can have a simple design.

In addition, the control unit can comprise both calculation means and memory means and can store calculations that have already been performed in the memory means and access them.

In principle, the continuous material can be of any design as long as it fulfils the function that the hook-like holding section can be formed from the carrier and is not plastically deformed when the workpiece is arranged on the hook-like holding section.

In order to ensure that current flows through the workpieces during processing, in particular during coating, in order to improve adhesion of the coating agent, it is advantageous if the holding device, in particular the continuous material forming the carrier and the at least one holding section, is electrically conductive and in particular comprises a metal such as iron, steel or copper.

If the continuous material forming the carrier and the at least one holding section is electrically conductive and in particular comprises a metal, this can be easily provided and formed by the provisioning device and by the deformation unit.

In addition, the metal construction allows sufficiently high forces to be absorbed due to the weight of the workpieces to be arranged on it.

In order to allow current to flow through the carriers comprising at least one hook-like holding section, it proves to be advantageous if the holding device comprises at least two receptacles fixed to the rack-like frame, which are assigned to a carrier, to which the carrier can be detachably fixed and through which the carrier can be connected to a current source and energised when fixed.

In addition, embodiments of the loading device are conceivable in which the holding device comprises at least two carriers which can be fixed or are fixed to the rack-like frame so that they run fundamentally parallel to one another.

In particular, if the holding device comprises at least two carriers, the arrangement of the hook-like holding sections with the horizontal areas and vertical areas in the plane of the frame or transverse to it is decisive for the number of workpieces that can be arranged, given the number and dimensions of the workpieces to be arranged.

In particular, if the holding device comprises at least two carriers, it can be provided in a further development of the loading device that the detection means of the detection device can detect a vertical minimum distance between two hook-like holding sections of a carrier for contact-free arrangement of the workpiece and/or a horizontal minimum distance between two hook-like holding sections of two neighbouring carriers, whereby the minimum distance between two hook-like holding sections determined by the control unit for contact-free arrangement of the workpiece comprises a vertical minimum distance between two holding sections on the same carrier and a horizontal minimum distance between two holding sections of two neighbouring carriers.

The fact that the detection means of the detection device can detect both a vertical minimum distance between two hook-like holding sections of a carrier and a horizontal minimum distance between two hook-like holding sections of two neighbouring carriers can ensure that the workpieces do not touch each other during processing, in particular during coating, and that this results in insufficient coating or, in the worst case, no coating at all in areas of the workpieces.

In principle it is conceivable that the carrier formed by the loading device is fixed manually to the frame. The degree of automation of the loading device can be increased if the loading device comprises at least one handling unit, which comprises at least one loading-handling means, through which the carriers made by the provisioning device can be accommodated on the provisioning device and arranged on the frame of the holding device.

In addition, it is conceivable that the workpieces are arranged manually on the hook-like carrier sections by operating staff. The degree of automation can be further increased if the handling unit comprises at least one loading-handling means by which a workpiece can be picked up and placed on a holding section of a carrier fixed to the frame and/or by which a holding device loaded with at least one workpiece can be transferred to a coating system.

In addition, the degree of automation of the loading device can be further increased if the loading device comprises at least one feed means on which workpieces can be placed, fed to the handling unit and gripped by the loading-handling means.

In addition, the problem is solved by a coating system for coating workpieces, with at least one loading device with at least one of the aforementioned features, with a conveyor system for transporting the at least one holding device of the loading device loaded with workpieces, with a coating unit, in which a holding device supplied with workpieces by the conveyor system can be coated with coating agent, with a heating unit which is arranged downstream of the coating unit and in which the coating agent can be cured, and with at least one unloading device for removing the holding device from the conveyor system and for removing the workpieces from the holding device.

Further features, details and advantages of the invention are apparent from the appended patent claims, from the drawing and from the following description of a preferred embodiment of the loading device and the coating system.

### BRIEF DESCRIPTION OF THE DRAWINGS

The drawings show:

FIG. 1A schematic top view of an embodiment of a loading device according to the invention;

FIG. 2A schematic top view of a deformation unit of the loading device in different process stages of the deformation;

FIG. 3A schematic top view of an embodiment of a coating system according to the invention;

### DETAILED DESCRIPTION

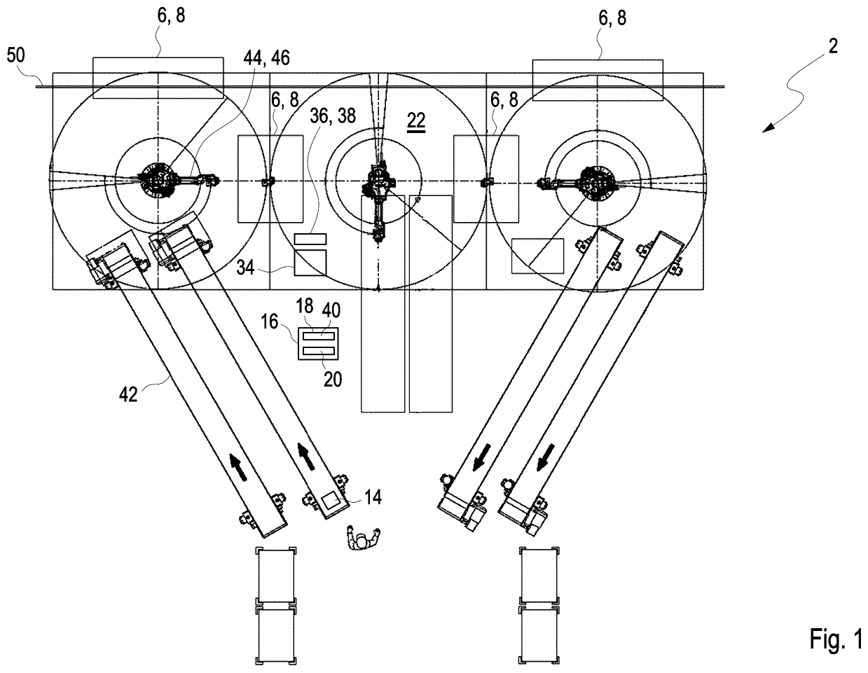

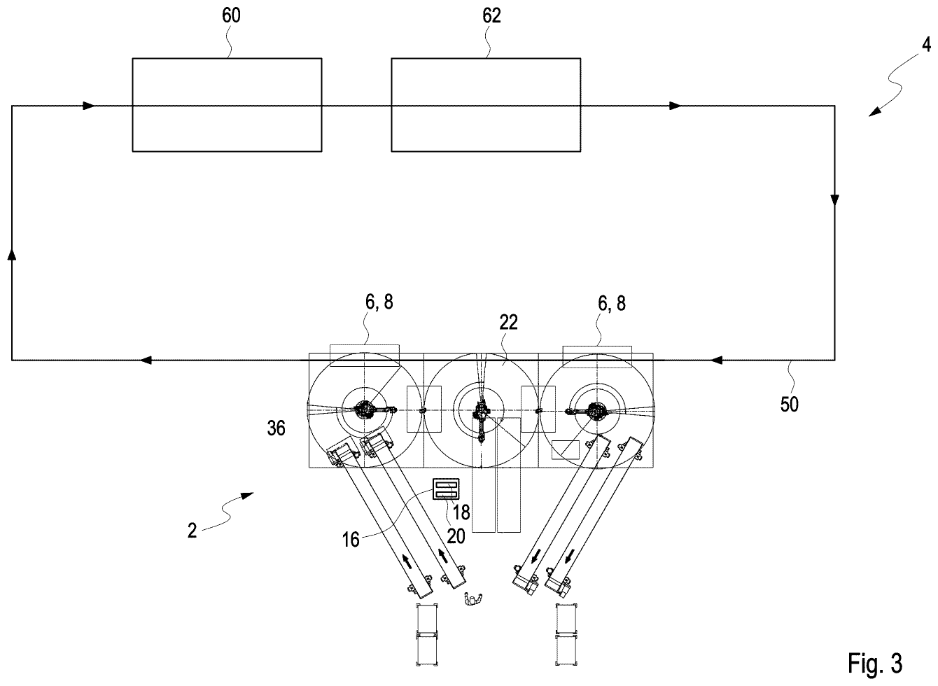

FIG. 1 shows a loading device for a coating system 4 (FIG. 3) labelled with the reference symbol 2. The loading device 2 comprises holding devices 6, which are shown only schematically in FIG. 1 and FIG. 3 and which each comprise at least one rack-like frame 8 and at least one carrier 10 manufactured on the frame 8 from a rod-like or wire-like continuous material.

The carriers 10 made from the wire-like continuous material are fixed to the frame 8 at both ends. Hook-like holding sections 12 are moulded on the carriers 10. A workpiece 14 to be processed can be arranged on the hook-like holding sections 12. In addition, the loading device 2 comprises a detection device 16, which comprises a detection means 18, by means of which at least the dimensions of the frame 8 and the workpiece 14 can be detected.

In addition, the detection device 16 comprises a control unit 20 by which, on the basis of the dimensions of the frame 8 and the workpiece 14, the dimensions of the at least one hook-like holding section 12 of the carrier 10 for contact-free arrangement of the workpiece 14 and the total length of the continuous material for moulding the carrier 10 can be determined.

In addition, the loading device 2 comprises a provisioning device 22 which co-operates functionally with the detection device 16. The carrier 10 can be produced by the provisioning device 22.

The provisioning device 22 comprises a continuous material carrier 34, which provides the continuous material forming the carrier 10. In addition, the provisioning device 22 comprises a deformation unit 36, by means of which a hook-like holding section 12 can be moulded by plastic deformation of the continuous material provided in an area-by-area manner in accordance with the determined dimensions and the determined minimum distance. In addition, the deforming unit 36 comprises a cutting means 38, by means of which the continuous material provided can be separated from the remaining continuous material carrier 34 when the total length is reached.

FIG. 1 shows an embodiment of the loading device 2, in which the detection means 18 of the detection device 16 comprises a sensor means 40. In order to transport workpieces 14 to the holding device 6, the loading device 2 comprises a feed means 42, on which workpieces 14 can be deposited and fed to the holding device 6. In order to arrange the workpieces 14 arriving at the holding device 6, the loading device 2 comprises a handling unit 44, which comprises a loading handling means 46, by means of which a workpiece 14 can be picked up and arranged on a holding section 12 of a carrier 10 fixed to the frame 8.

In addition, the handling unit 44 comprises a provision-handling means 48, by means of which the carrier 10 produced by the provisioning device 22 can be picked up at the provisioning device 22 and arranged on the frame 8 at the holding device 6.

In the embodiment example shown in FIG. 1, the frame 8 of the holding device 6 is held by the loading handling means 46 and arranged on a conveyor system 50 of the coating system 4.

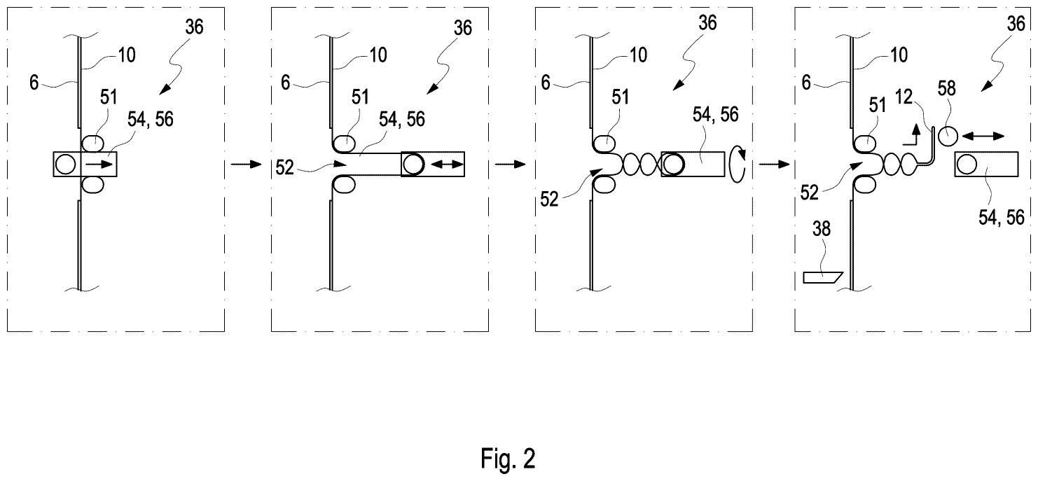

FIG. 2 shows a continuous material during the production of a carrier 10 by the provisioning device 22. The deformation unit 36 of the provisioning device 22 comprises a contact means 51, which is arranged parallel to the direction of the extension of the continuous material provided. The contact means 51 comprises a continuous opening 52.

In addition, the deformation unit 36 comprises a pulling means 54 which grips the continuous material provided on a side facing away from the contact means 51 and transfers it transversely or obliquely to the direction of extension of the continuous material provided to the hook-like holding section 12 to be formed through the opening 52.

In addition, the deformation unit 36 comprises a twisting means 56, through which the hook-like holding section 12 to be formed, which is transferred through the opening 52 of the contact means 51, can be twisted.

In addition, the deformation unit 36 comprises a bending means 58, through which the hook-like holding section 12 to be formed, which is transferred through the opening 52 of the contact means 51, can be deformed by bending.

FIG. 3 shows a coating system 4. The elements of the loading device 2 shown there correspond to the illustration in FIG. 1, which is why reference is made to the explanations and reference symbols shown there. The coating system 4 comprises a coating unit 60, in which workpieces 14 supplied by the conveyor system 50 are coated with coating agent.

From the coating unit 60, the coated workpieces 14, in particular the holding device 6, on which the workpieces 14 are attached to the hook-like holding sections 12 of the carriers 10, which are fixed to the frame 8 of the holding device 6, are transferred to a heating unit 62 by the conveyor system 50. The coating materials harden there.

The conveyor system 50 then transports the holding device 6 to an unloading device 64, at which the holding device 6 is removed from the conveyor system 50 and at which the coated workpieces 14 are removed from the holding device 6.

The features of the invention disclosed in the above description, in the claims and in the drawing may be essential, both individually and in any combination, in the realisation of the invention in its various embodiments in frame 8 of the scope of protection of the following claims.

### REFERENCE SYMBOL LIST

2 Loading device
4 Coating system
6 Holding device
8 Frame
10 Carrier
12 Holding section
14 Workpiece
16 Detection device
18 Detection means
20 Control unit
22 Provisioning device
34 Continuous material carrier
36 Deformation unit
38 Cutting means
40 Sensor means
42 Feed means
44 Handling unit
46 Loading handling means
48 Provisioning handling means
50 Conveyor system
51 Contact means
52 Opening
54 Pulling means
56 Twisting means
58 Bending means
60 Coating unit
62 Heating unit
64 Unloading device

1. A loading device for a coating system with at least one holding device which comprises:
at least one rack-like frame and at least one carrier made of a rod-like or wire-like continuous material, which can be or is secured with one end to the frame and on which at least one hook-like holding section is formed, on which a workpiece to be coated can be arranged, with at least one detection device which comprises a detection means, by which at least the dimensions of the frame and of the workpiece can be detected, and which comprises at least one control unit, by which, on the basis of the dimensions of the frame and the workpiece, the dimensions of the at least one hook-like holding section and of a minimum distance between two hook-like holding sections on the carrier for contact-free arrangement of the workpiece and by which the total length of the continuous material for forming the carrier can be determined, and
with at least one provisioning device which interacts functionally with the detection device, by which the carrier can be produced, which provides a continuous material carrier, which provides the continuous material forming the carrier, which provides a deformation unit, by which a hook-like holding section can be moulded by a region-wise plastic deformation of the provided continuous material in accordance with the determined dimensions and the determined minimum distance, and which provides a cutting means, with which the provided continuous material can be cut once the total length of the remaining continuous material carrier is achieved.

2. The loading device according to claim 1, wherein the carrier and the at least one hook-like holding section form a common one-piece component.

3. The loading device according to claim 1, wherein the at least one deformation unit of the provisioning device comprises a contact means which is arranged parallel to the direction of extension of the continuous material provided and which comprises a continuous opening, and in that the at least one deforming unit of the provisioning device comprises a pulling means which engages behind the continuous material provided on a side facing away from the contact means and transfers the hook-like holding section to be formed through the opening transversely or obliquely to the direction of extension of the continuous material provided.

4. The loading device according to claim 3, wherein the at least one deformation unit of the provisioning device comprises at least one twisting means, by means of which the hook-like holding section to be formed, which is transferred through the opening of the contact means, can be plastically deformed by twisting and/or in that the at least one deformation unit of the provisioning device comprises at least one bending means by means of which the hook-like holding section to be formed, which is transferred through the opening of the contact means, can be deformed by bending.

5. The loading device according to claim 1, wherein at least one of the at least one hook-like holding section formed on the carrier comprises, in the arrangement of the carrier fixed to the frame, a horizontal region which opens into the carrier, and a vertical region which opens into the horizontal region and has a free end for arranging the workpiece on the side facing away from the horizontal region, wherein the hook-like holding section is arranged with both the horizontal region and the vertical region extending parallel to a plane spanned by the frame, or wherein the hook-like holding section is arranged with the horizontal region or with the vertical region extending perpendicular to a plane spanned by the frame.

6. The loading device according to claim 1, wherein at least one of the at least one detection means comprises at least one manually operable input means, by which at least the dimensions of the frame and of the workpiece can be entered and/or in that at least one of the at least one detection means comprises at least one sensor means, by which at least the dimensions of the frame and of the workpiece can be detected automatically.

7. The loading device according to claim 1, wherein the control unit comprises a calculating means by means of which the dimensions of the at least one hook-like holding section of the minimum distance between two hook-like holding sections and the total length of the continuous material can be calculated and/or in that the control unit comprises a memory means in which the values for the dimensions of the at least one hook-like holding section, the minimum distance between two hook-like holding sections and the total length of the continuous material are stored.

8. The loading device according to claim 1, wherein the holding device is electrically conductive.

9. The loading device according to claim 1, wherein the holding device comprises at least two receptacles which are fixed to the rack-like frame and are assigned to a carrier, to which the carrier can be detachably fixed and through which the carrier can be connected to a power source and energised when fixed.

10. The loading device according to claim 1, wherein the holding device comprises at least two carriers which can be fixed or are fixed to the rack-like frame running essentially parallel to one another.

11. The loading device according to claim 1, wherein a vertical minimum distance between two hook-like holding sections of a carrier for contact-free arrangement of the workpiece and/or a horizontal minimum distance between two hook-like holding sections of two adjacent carriers can be detected by the detection means of the detection device, wherein the minimum distance determined by the control unit between two hook-like holding sections for the contact-free arrangement of the workpiece comprises a vertical minimum distance between two holding sections on the same carrier and a horizontal minimum distance between two holding sections of two neighbouring carriers.

12. The loading device according to claim 1, wherein at least one handling unit, which comprises at least one provisioning handling means, by means of which the carrier produced by the provisioning device can be picked up at the provisioning device and can be arranged on the frame of the holding device.

13. The loading device according to claim 12, wherein the handling unit comprises at least one loading handling means, by means of which a workpiece can be picked up and arranged on a holding section of a carrier fixed to the frame and/or by means of which a holding device loaded with at least one workpiece can be transferred to a coating system.

14. The loading device according to claim 1, wherein at least one feed means, on which workpieces can be deposited, fed to the handling unit and gripped by the loading handling means.

15. A coating system for coating workpieces, having a loading device according to claim 1, having a conveyor system for transporting the at least one holding device, loaded with workpieces, of the loading device, having a coating unit, in which a holding device loaded with workpieces and fed by the conveyor system can be coated with coating agent, with a heating unit which is arranged downstream of the coating unit and in which the coating agent can be cured, and with at least one unloading device for removing the holding device from the conveyor system and for removing the workpieces from the holding device.
